(19) United States
(12) Patent Application Publication
(10) Pub. No.: US 2005/0120892 A1
(43) Pub. Date: Jun. 9, 2005

(54) Utensil

(76) Inventor: Alan James Campbell McKee, Middlesex (GB)

Correspondence Address: Christopher D Wood;Wood & Eisenberg, 2009 N 14th Street, Suite 706, Arlington, VA, 22201, US

(21) Appl. No.: 10/502,206

(22) PCT Filed: Jan. 23, 2003
(86) PCT No.: PCT/GB03/00294

(30) Foreign Application Priority Data
Jan. 25, 2002 (GB) 0201772.1

(51) Int. Cl. A23N 7/00

(52) U.S. Cl. 99/584

(57) ABSTRACT

The invention relates to a utensil which prepares the surface for food items prior to cooking. A utensil for the preparation of food items comprising a first part (5) defining a container for receiving in use food items through an opening of the first part (5) and means (6) for closing the opening of the first part wherein at least a portion of an inner surface of the first part (5) comprises protrusions (4) which said food items may be brought into contact with, in use, by shaking the utensil so as to roughen or abrade surfaces of said food items.

The invention relates to a utensil which prepares the surface of food items prior to cooking. In particular the utensil may be used with parboiled potatoes prior to roasting to give them a crisp and crunchy surface.

Generally, roast potatoes have a smooth, tough and leathery surface.

The object of this invention is to provide a method and means to break the surface of food items such as potatoes to roughen the items creating a fluffy and ragged surface prior to cooking, for example by roasting. Thus, giving a more desirable crispy and crunchy texture to their surface after cooking.

The present invention provides a utensil for the preparation of food items comprising a first part defining a container for receiving in use food items through an opening of the first part and means for closing the opening of the first part wherein at least a portion of an inner surface of the first part comprises protrusions which said food items may be brought into contact with, in use, by shaking the utensil so as to roughen or abrade surfaces of said food items.

The present invention further provides a method of preparing food items comprising the steps of inserting said food items into a utensil having a first part defining a container, closing said container, and shaking said utensil so as to cause said food items to be brought into contact with protrusions provided on at least a portion of an inner surface of the first part so as to roughen or abrade surfaces of said food items.

The invention will now be further described, by way of example only, with reference to the accompanying drawings in which:-

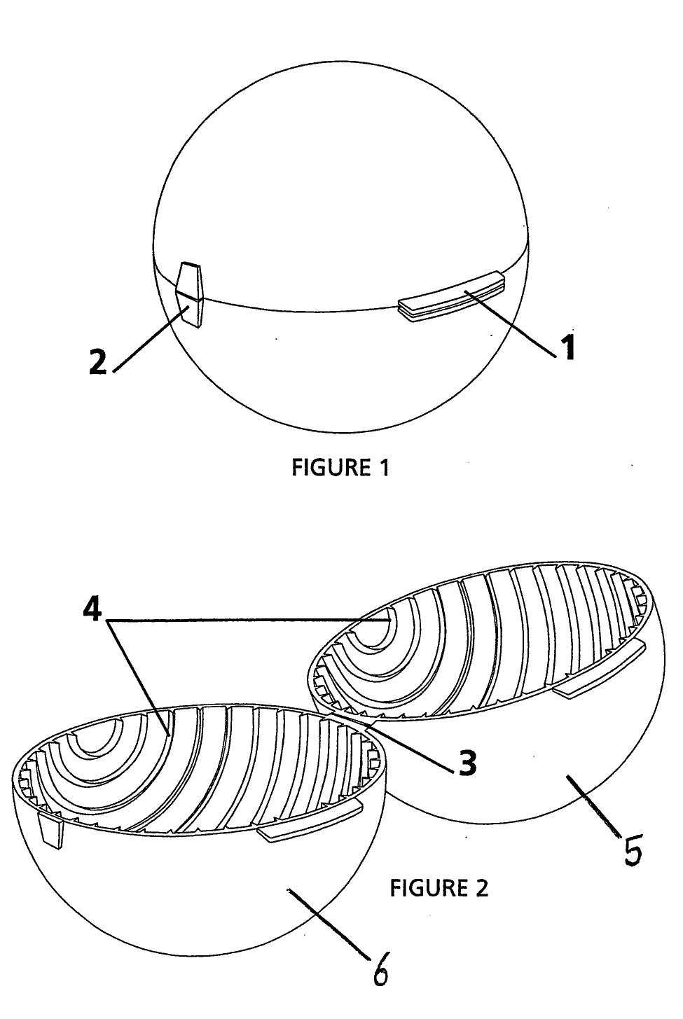

FIG. 1 is a perspective view of a utensil according to the present invention in a closed state; and

FIG. 2 shows the utensil of FIG. 1 in an open state.

As shown in FIG. 1, the utensil comprises two hemi-spherical parts 5, 6 which when closed form a container which is spherical in shape and has a handle 1 to grip the object fixed to both sides and a clamp. 2 to lock both parts 5, 6 together.

FIG. 2 shows the object open with both parts 5, 6 held together by a hinge 3. The inside surface of both parts 5, 6 is covered in a series of ridges 4. The ridges 4 are preferably continuous over substantially the entire inner surface.

In use, the parboiled potatoes are placed into the utensil, the two parts 5, 6 are closed and locked securely. The utensil is then briefly shaken to cause the potatoes to strike against the inside ridges 4 to abrade and impact the surfaces until the surfaces become roughened and fluffy. The potatoes may also contact the body of the two parts of the container as in between the ridges 4. The parts 5, 6 are then opened and the potatoes are placed on a roasting tin with cooking oil or oil/butter and roasted in the oven until the surfaces become crisp and crunchy.

Preferably, the utensil is made of plastic but it could alternatively be made of metal and can vary in size depending whether it is intended to be used in the household or restaurant.

The utensil may be made transparent to allow the user to see when sufficient roughening has been applied to the potatoes.

The parts 5, 6 may be made separate from one another rather than being hinged. Alternative locking means may be provided to conjoin the parts in use such as a snap fit arrangement or twist-lock arrangement.

The parts 5, 6 may be made in shapes other than hemi-spherical without departing from the present invention.

The ridges 4 may be made discontinuous. Spikes or similar protrusions may be used instead of ridges. The ridges or other protrusions may be provided on part only of the inner surface of parts 5, 6 and/or on only one or other of parts 5, 6.

The utensil advantageously lends itself to being manufactured by moulding.

1. A utensil for the preparation of food items, comprising: a first part, wherein said first part defines a container having an inner surface and a closable opening, wherein said container can receive food items through said opening, wherein at least a portion of said inner surface comprises protrusions which the food items may be brought into contact with by shaking the utensil so as to roughen or abrade surfaces of the food items.

2. The utensil of claim 1 further comprising a second part which may be conjoined with the first part and can be used to close said opening of said first part, wherein said second part comprises an inner surface.

3. The utensil of claim 2 wherein at least a portion of said inner surface of said second part comprises protrusions which the food items may be brought into contact with, in use, by shaking said utensil so as to roughen or abrade the surfaces of the food items.

4. The utensil of claim 3, wherein said first and second parts are hinged together.

5. The utensil of claim 3, wherein said first and second parts are separable.

6. The utensil of claim 3, wherein said first and second parts are hemi-spherical.

7. The utensil of claim 3, wherein the said protrusions are in the form of continuous ridges.

8. The utensil of claim 3, wherein said protrusions are in the form of discontinuous ridges.

9. The utensil of claim 3, where said protrusions are in the form of spikes.

10. The utensil of claim 3 further comprising a handle.

11. The utensil of claim 3, wherein said utensil is plastic.

12. Use of a utensil as claimed in any of claims 1 to 11.

13. A method of preparing food items comprising the steps of inserting said food items into a utensil having a first part defining a container, closing said container, and shaking said utensil so as to cause said food items to be brought into contact with protrusions provided on at least a portion of an inner surface of the first part so as to roughen or abrade surfaces of said food items.

14. The method of claim 13 wherein said first part is closed by conjoining a second part to said first part.

15. The method of claim 13, wherein the food items are potatoes.

16. The method of claim 13 wherein the food items are brought into contact with a part of said container as well as said protrusions.

17. The utensil of claim 1, wherein said utensil is made of plastic.

18. The utensil of claim 1, wherein said utensil is made of metal.

19. The utensil of claim 1 further comprising a handle.

20. The utensil of claim 1, wherein said protrusions are in the form of continuous ridges.

21. The utensil of any of claim 1, wherein said protrusions are in the form of discontinuous ridges.

22. The utensil of claim 1, wherein said protrusions are in the form of spikes.

23. The utensil of claim 2, wherein said utensil is made of plastic.

24. The utensil of claim 2, wherein said utensil is made of metal.

25. The utensil of claim 2 further comprising a handle.

26. The utensil of claim 2, wherein said protrusions are in the form of continuous ridges.

27. The utensil of any of claim 2, wherein said protrusions are in the form of discontinuous ridges.

28. The utensil of claim 2, wherein said protrusions are in the form of spikes.

29. The utensil of claim 2, wherein said first and second parts are hinged together.

30. The utensil of claim 2, wherein said first and second parts are separable.

31. The utensil of claim 2, wherein said first and second parts are hemi-spherical.

32. The utensil of claim 2, wherein said first and second parts conjoin as a snap fit arrangement.

33. The utensil of claim 2, wherein said first and second parts conjoin as a twist-lock arrangement.

34. The utensil of any of claim 3, wherein said protrusions are in the form of discontinuous ridges.

35. The utensil of claim 3, wherein said first and second parts conjoin as a snap fit arrangement.

36. The utensil of claim 3, wherein said first and second parts conjoin as a twist-lock arrangement.
